(19) United States
(12) Patent Application Publication
(10) Pub. No.: US 2009/0035530 A1
(43) Pub. Date: Feb. 5, 2009

(54) Textile sheet material, especially label, comprising a chip

(76) Inventor: Francisco Speich, Gipf-Oberfrick (CH)

Correspondence Address: George Pappas, 919 S. Harrison Street, Suite 300, Fort Wayne, IN, 46802, US

(21) Appl. No.: 11/989,034

(22) PCT Filed: Jun. 1, 2006
(86) PCT No.: PCT/CH2006/000293

§ 371 Date: Jan. 18, 2008

(30) Foreign Application Priority Data
Jul. 22, 2005 (CH) 1221/05

(51) Int. Cl. B32B 3/00

(52) U.S. Cl. 428/190

(57) ABSTRACT

The invention relates to a textile sheet material, especially a label, containing a chip that is connected to electrical conductors arranged on the sheet material. According to the invention, at least one wire stitch is used to improve the fixing of the chip to the sheet material.

This application claims priority of PCT application PCT/CH2006/000293 A1 having a priority date of Jul. 22, 2005, the disclosure of which is incorporated herein by reference.

### TECHNICAL FIELD

The invention relates to a textile sheet material, especially a label, comprising a chip.

### BACKGROUND OF THE INVENTION

A textile sheet material of the type mentioned initially has been disclosed several times, for example in DE 10155935A. In the case of such textile sheet materials, the contact-connection of the chip to the conductor, on the one hand, and the fastening of the chip to the textile sheet material, on the other hand, give rise to problems.

### SUMMARY OF THE INVENTION

The object of the invention is to improve the fastening of the chip in the case of a textile sheet material of the type mentioned initially.

The fact that the chip is connected to the sheet material using at least one staple results in a simple and permanent connection between the chip and the sheet material which can be carried out quickly.

The chip can be directly placed on the sheet material. In this case, it is advantageous, for the chip to be at least partially arranged in an enclosure and for it to be preferably fastened in the latter in a watertight manner using glue. In this case, this enclosure may have laterally protruding shoulders which are used to support the chip on the sheet material.

It is more advantageous if, the chip is arranged in an opening of the sheet material, with the result that it is integrated in the sheet material to a greater extent and protrudes to a lesser extent. For this purpose, it is advantageous if, the chip has laterally protruding flanges at least on mutually opposite sides, which flanges are used to support the chip on the opening edge of the sheet material.

A particularly simple type of fastening, according to which the staple engages over the chip in the manner of a bracket and secures the chip on that side of the sheet material which faces away from the chip using holding feet which are angled with respect to the sheet material. In this case, the staple may already be permanently connected to the chip, if appropriate. According to another type of fastening, the chip has staples on at least two sides which face away from one another, said staples containing respective shanks that are permanently connected to the chip, continuing to run through the sheet material and having, on the other side of the sheet material, holding feet which are angled with respect to the latter.

The chip may either have contacts which are directly connected to the electrical conductors. However, it may also be expedient for the chip to have contacts which are connected to the electrical conductors via staples. The electrical connecting points can be improved by arranging conductive glue at the electrical connecting points. This improves, on the one hand, the stability of the connecting points and, on the other hand, their electrical conductivity.

It is particularly advantageous if the chip is embedded, with its connections to the conductors on the sheet material, in a casting compound. This improves the arrangement of the chip on the sheet material and protects it from external influences.

### BRIEF DESCRIPTION OF THE DRAWINGS

Exemplary embodiments of the invention are described in more detail below using the drawings, in which:

FIG. 1 shows a view from below of a first textile sheet material on which a chip has been placed;

FIG. 2 shows a vertical section through the textile sheet material of FIG. 1;

FIG. 3 shows a view from below of a second textile material in which a chip has been inserted; and

FIG. 4 shows a vertical section through the textile sheet material of FIG. 3.

### DETAILED DESCRIPTION OF THE PREFERRED EMBODIMENTS

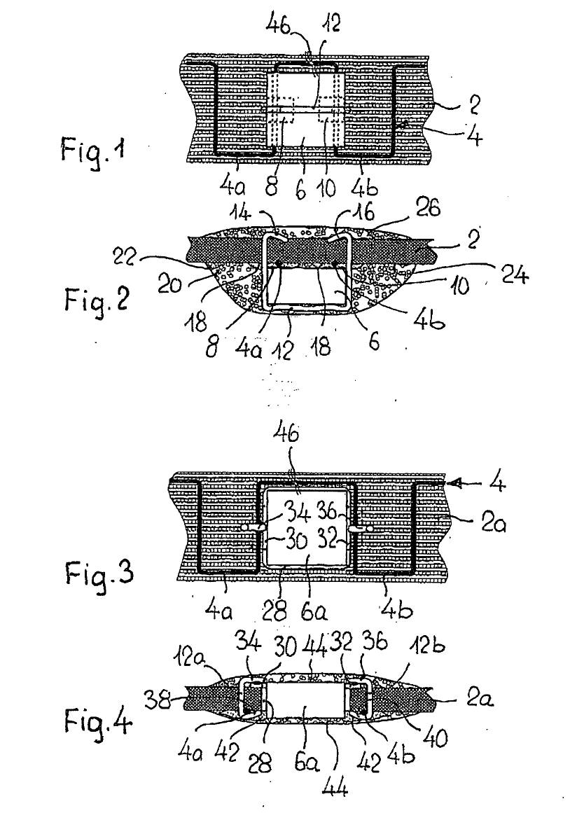

FIGS. 1 and 2 show a textile sheet material 2 which is preferably a woven fabric on which or in which an electrical conductor 4, which is used as an antenna for example, is arranged. The conductor 4 can be directly incorporated during manufacture of the textile sheet material 2 or can be subsequently applied to the textile sheet material 2. A chip 6 has two contact points 8, 10 with which it rests on the conductors 4 of the textile sheet material 2. A staple 12 engages around the chip 6 and pierces the textile sheet material 2. On that side of the textile sheet material 2 which faces away from the chip 6, the staple 12 has holding feet 14, 16 which are bent around with respect to the textile sheet material 2. These holding feet press the textile sheet material 2 against the conductors 4 and prestress the latter with respect to the contact points 8, 10 of the chip. For the purpose of improvement, the contact regions of the contact points 8, 10 are embedded, with the conductors 4, in a conductive glue 18.

The chip 6 is arranged in an enclosure 20 which has already been fitted before the chip is fitted to the textile sheet material. In this case, the chip may be arranged in the enclosure in a watertight manner using a glue. Laterally protruding shoulders 22, 24 are used to put the chip down on the sheet material 2. However, it is also possible for the enclosure 20 to be subsequently applied to the chip, which is fastened to the textile sheet material, in the form of a casting compound. Such a casting compound 26 may also be arranged on that side of the sheet material 2 which faces away from the chip 6 in order to protect the arrangement of the holding feet 14, 16 on the textile sheet material 2.

FIGS. 3 and 4 show a further exemplary embodiment of a textile sheet material 2 with conductors 4, in which a punched-out opening 28, into which the chip 6a is inserted, is arranged. The chip 6a has, on mutually opposite sides, laterally protruding flanges 30, 32 to which shanks 34, 36 of staples 12a, 12b are fastened, for example by means of welding or soldering. The staples 12a, 12b respectively engage through the textile sheet material and have, on the side facing away from the flanges 30, 32, holding feet 38, 40 which are bent with respect to the textile sheet material 2a. In this case, the holding feet 38, 40 respectively engage around a conductor 4 and thus establish a conductive connection between the conductor 4 and the flanges 30, 32 which are in the form of contact points. The point at which the staples 12a, 12b are connected to the conductors 4 is expediently additionally protected with an electrically conductive drop of glue 42. The chip 6a, together with its staples 12a, 12b and the connecting points to the conductors, is covered on both sides of the textile sheet material using a casting compound 44 and is thus protected against environmental influences.

The conductor 4 is generally arranged on the textile sheet material 2, 2a in the form of a continuous thread and is respectively provided with an interruption 46 between its connecting points in the region of the chip 6, 6a in order to provide the chip 6, 6a with respective conductor sections 4a, 4b which form the antenna needed to operate the chip. The chip is an integrated circuit (IC), in particular a transponder IC, a so-called RFID chip. Such a textile sheet material comprising a chip is used, for example, as an intelligent label, a so-called smart label, which will become very important in future in the textile sector as part of logistics, the manufacturing process, sales and the maintenance and cleaning of textiles. Such intelligent labels may be equipped with transponder systems (so-called RFID tags) which can be contactlessly called and can be used to retrieve textile-specific information, for example. Preferred areas of use for textiles equipped in this manner are, for example, corresponding labeling of hired clothes, clothes in laundries or in storage. It is particularly important in this context for the intelligent label to be resistant to the methods which are usually used to manufacture and clean textiles and for it to withstand the intended use of the textiles. Such intelligent labels are also used for theft protection in shops. The range of use is so varied that it can hardly be grasped.

### LIST OF REFERENCE NUMERALS

2 Textile sheet material
2a Textile sheet material
4 Conductor
4a Conductor section
4b Conductor section
6 Chip
6a Chip
8 Contact point
10 Contact point
12 Staple
12a Staple
12b Staple
14 Holding foot
16 Holding foot
18 Glue
20 Enclosure
22 Shoulders
24 Shoulders
26 Casting compound
28 Opening
30 Flange
32 Flange
34 Shank of the staple
36 Shank of the staple
38 Holding foot
40 Holding foot
42 Glue
44 Casting compound
46 Interruption

1. A textile sheet material, especially a label, comprising a chip which is connected to electrical conductors which are arranged on or in the sheet material, characterized in that the chip is connected to the sheet material using at least one staple.

2. The sheet material as claimed in claim 1, characterized in that the chip is placed on the sheet material.

3. The sheet material as claimed in claim 1, characterized in that the chip is at least partially arranged in an enclosure and is preferably fastened in the latter in a watertight manner using glue.

4. The sheet material as claimed in claim 3, characterized in that the enclosure has laterally protruding shoulders which are used to support the chip on the sheet material.

5. The sheet material as claimed in claim 1, characterized in that the chip is arranged in an opening of the sheet material.

6. The sheet material as claimed in claim 5, characterized in that the chip has laterally protruding flanges at least on mutually opposite sides, which flanges are used to support the chip on the opening edge of the sheet material.

7. The sheet material as claimed in claim 1, characterized in that the staple engages over the chip in the manner of a bracket and secures it on that side of the sheet material which faces away from the chip using holding feet which are angled with respect to the sheet material.

8. The sheet material as claimed in claim 1, characterized in that the chip has staples on at least two sides which face away from one another, said staples containing a respective shank that is connected to the chip, running through the sheet material and having, on the other side of the sheet material, holding feet which are angled with respect to the latter.

9. The sheet material as claimed in claim 1, characterized in that the chip has contacts which are directly connected to the electrical conductors.

10. The sheet material as claimed in claim 1, characterized in that the chip has contacts which are connected to the electrical conductors via staples.

11. The sheet material as claimed in claim 1, characterized in that conductive glue is arranged at the electrical connecting points.

12. The sheet material as claimed in claim 1, characterized in that the chip is embedded, with its connections to the conductors on the sheet material, in a casting compound.

13. The sheet material as claimed in claim 2, characterized in that the chip is at least partially arranged in an enclosure and is preferably fastened in the latter in a watertight manner using glue.

14. The sheet material as claimed in claim 13, characterized in that the enclosure has laterally protruding shoulders which are used to support the chip on the sheet material.

15. The sheet material as claimed in claim 2, characterized in that the staple engages over the chip in the manner of a bracket and secures it on that side of the sheet material which faces away from the chip using holding feet which are angled with respect to the sheet material.

16. The sheet material as claimed in claim 2, characterized in that the chip has staples on at least two sides which face away from one another, said staples containing a respective shank that is connected to the chip, running through the sheet material and having, on the other side of the sheet material, holding feet which are angled with respect to the latter.

17. The sheet material as claimed in claim 2, characterized in that the chip has contacts which are directly connected to the electrical conductors.

18. The sheet material as claimed in claim 2, characterized in that the chip has contacts which are connected to the electrical conductors via staples.

19. The sheet material as claimed in claim 2, characterized in that conductive glue is arranged at the electrical connecting points.

20. The sheet material as claimed in claim 2, characterized in that the chip is embedded with its connections to the conductors on the sheet material in a casting compound.
